(19) United States
(12) Patent Application Publication
(10) Pub. No.: US 2026/0238649 A1
(43) Pub. Date: Aug. 13, 2026

(54) INFORMATION MANAGEMENT CONTROLLER, INFORMATION MANAGEMENT CONTROL SYSTEM, INFORMATION MANAGEMENT CONTROL METHOD, AND RECORDING MEDIUM

(71) Applicant: Mitsubishi Electric Corporation, Tokyo (JP)

(72) Inventors: Koji NAGAMATSU, Tokyo (JP); Yasuhiro TOYAMA, Tokyo (JP); Hidematsu HAYASHI, Tokyo (JP)

(73) Assignee: Mitsubishi Electric Corporation, Tokyo (JP)

(21) Appl. No.: 19/160,038

(22) PCT Filed: Mar. 8, 2023
(86) PCT No.: PCT/JP2023/008848

§ 371 Date: Aug. 27, 2025

(51) Int. Cl. H04L 9/40

(52) U.S. Cl. CPC H04L 63/105

(57) ABSTRACT

To manage content data including operation data of a management target device and control access to the content data, an information management controller includes an attribute information appender to append attribute information including generator information of the content data to the content data based on a preset rule, a role generator to generate role information including the generator information of the content data and indicating a condition for allowing access to the content data, an assignor to identify a provider of the content data based on association information and assign the role information to a user in a receiver of the content data authorized by the identified provider, and a determiner to determine whether access is permitted based on the attribute information appended to the content data and the condition indicated by the role information assigned to the user requesting access to the content data.

### TECHNICAL FIELD

The present disclosure relates to an information management controller, an information management control system, an information management control method, and a program.

### BACKGROUND ART

Role-based access control (RBAC) is known as a technique for strengthening the security of an information system. For example, Patent Literature 1 describes an information system that controls access to an information resource based on an abstract role determined by an attribute of a user and access permission associated with the abstract role.

### CITATION LIST

### Patent Literature

Patent Literature 1: Unexamined Japanese Patent Application Publication No. 2007-4549

### SUMMARY OF INVENTION

### Technical Problem

This information system sets one access permission per role. However, information managed by the information system is provided by various providers. The information system described in Patent Literature 1 thus has difficulty in flexibly setting access permission for, for example, each provider. Newly setting and managing access permission with different systems for different providers takes much time and effort. The information system is thus to be improved to appropriately manage permission to access information provided by various providers with less time and effort.

In response to the above issue, an objective of the present disclosure is to provide an information management controller, an information management system, an information management method, and a program that can appropriately manage permission to access information provided by various providers with less time and effort.

### Solution to Problem

To achieve the above objective, an information management controller according to an aspect of the present disclosure is an information management controller for managing content data including operation data of a management target device and controlling access to the content data. The information management controller includes an attribute information appender, a role generator, an assignor, and a determiner. The attribute information appender appends attribute information to the content data based on a preset rule. The attribute information includes generator information for identifying a device being a generator of the content data. The role generator generates role information including the generator information of the content data. The role information indicates a condition for allowing access to the content data. The assignor identifies a provider of the content data based on association information including the generator information included in the role information generated by the role generator in a manner associated with the provider of the content data generated by the device identified by the generator information. The assignor assigns the role information generated by the role generator to a user in a receiver of the content data authorized by the identified provider. The determiner determines whether a user requesting access to the content data is permitted to access the content data based on the attribute information appended to the content data and the condition indicated by the role information assigned to the user.

### Advantageous Effects of Invention

The structure according to the above aspect of the present disclosure generates role information indicating the condition for permitting access to the content data and identifies the provider based on association information including the generator information included in the role information in a manner associated with the provider of the content data generated by the device identified by the generator information. The information management controller assigns the role information to the user in the receiver of the content data authorized by the identified provider. The structure then determines whether access to the content data is permitted based on the attribute information appended to the content data and the condition indicated by the role information assigned to the user requesting access to the content data. The structure can thus appropriately manage permission to access information provided by various providers with less time and effort.

### BRIEF DESCRIPTION OF DRAWINGS

FIG. 1 is a diagram of an information management controller according to an embodiment of the present disclosure;

FIG. 2 is a diagram of an example of attribute management information held by an attribute manager illustrated in FIG. 1;

FIG. 3 is a diagram of an example of a combination table held by a role generator illustrated in FIG. 1;

FIG. 4A is a diagram of an example of a user table held by the role generator illustrated in FIG. 1;

FIG. 4B is a diagram of an example of a generator table held by the role generator illustrated in FIG. 1;

FIG. 5 is a diagram of an example of a custom role creation screen displayed on a terminal illustrated in FIG. 1;

FIG. 6 is a diagram of an example of a role definition table generated by the role generator illustrated in FIG. 1;

FIG. 7 is a diagram of an example of role groups of custom roles collectively managed and generated by the role generator illustrated in FIG. 1;

FIG. 8 is a diagram of an example of a change parameter setting screen displayed on the terminal illustrated in FIG. 1;

FIG. 9 is a diagram of an example of assignment information generated by the role generator illustrated in FIG. 1;

FIG. 10 is a block diagram of the information management controller according to the embodiment, illustrating the physical structure;

FIG. 11 is a diagram of an example of an input screen displayed on the terminal illustrated in FIG. 1; and

FIG. 12 is a flowchart of an access control process performed by the information management controller.

### DESCRIPTION OF EMBODIMENTS

An information management controller, an information management control system, an information management control method, and a program according to an embodiment of the present disclosure are described below with reference to the drawings. Like reference signs denote like or corresponding components in the drawings.

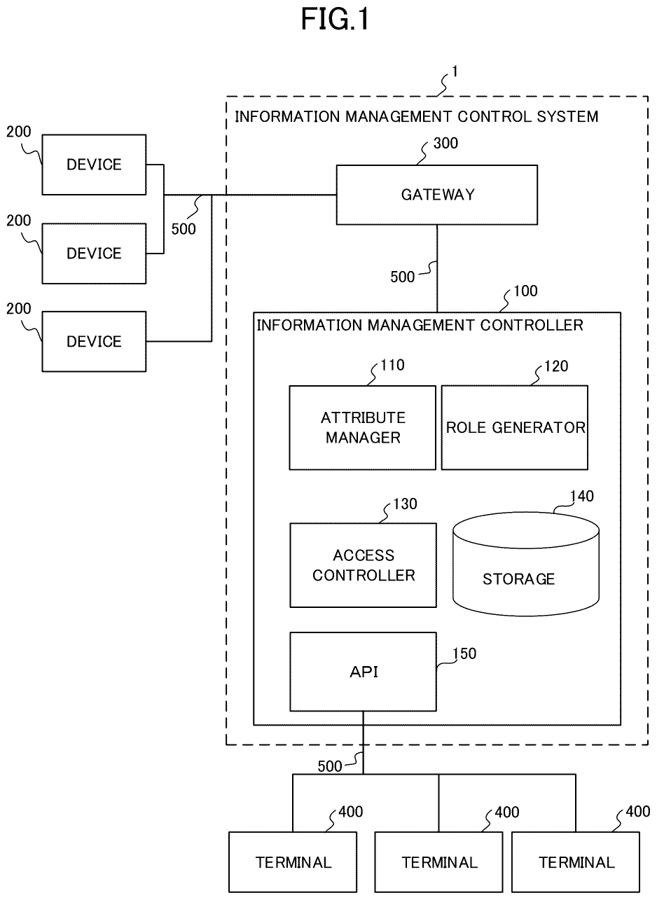

In the example described below, an information management controller according to the present embodiment is used in an information management control system 1 illustrated in FIG. 1.

The information management control system 1 registers information provided by an information provider with a storage 140 using an information management controller 100 that provides a cloud computing service to control access to the registered information. Access to the information is limited to an information receiver company authorized by an information provider company. Accessible information is limited to items authorized by the information provider company. More specifically, the information management control system 1 is used by multiple end user companies that operate devices including factory automation (FA) devices installed at a factory and maintenance companies that support maintenance of the devices and factory lines. The maintenance companies access maintenance target devices through a public wide area network using maintenance terminals to remotely provide a support operation for maintenance of the target device to the end user companies. The information management controller 100 is managed by the end user companies and management companies different from the maintenance companies. When providing maintenance support, the maintenance companies access information possessed by the end user companies. In the example described below, a user in a maintenance company accesses information provided by an end user company.

The information management control system 1 stores various items of content data provided by each end user company. The content data is provided with attribute information including a confidential level indicating the level of confidentiality of data. The content is information mainly about management target devices 200, including information for maintenance. For example, the content data includes operation data indicating the operation state of each device 200 collected by the device 200, data output from various sensors included in the device 200, and data about the device 200 possessed by the corresponding end user company, such as drawing data, a task history, a maintenance history, a part master, and a manual. When a maintenance company serves as an information provider, the content data may be data added through the user terminal of the maintenance company to the information management control system 1, such as a manual or a maintenance history provided by the maintenance company to the corresponding end user company.

The information management control system 1 generates a custom role for which a combination of accessible content data and operation permission for the content data is set. The information management control system assigns the custom role to a user. The operation permission indicates, for example, permission to perform specific operations on data, such as browsing, adding, updating, and deleting data. When the user accesses content data, the information management control system 1 determines whether the user has permission to access the content data based on the custom role assigned to the user.

Referring back to FIG. 1, the information management control system 1 includes the information management controller 100 that controls access to content data stored in the storage 140 and a gateway 300 that transmits data collected from the devices 200 installed at a factory(s) to the information management controller 100. The information management control system 1 is connected to perform communication through a network 500. A user in a maintenance company or an end user company accesses the content data using a terminal 400 through an application programming interface (API) 150 in the information management controller 100. In the illustrated example, the information management control system 1 includes the single gateway 300, but may include two or more gateways 300 connected to the information management controller 100, as appropriate for the number of end user companies that use the information management control system 1.

The information management controller 100 includes an attribute manager 110 that manages attributes of content data, a role generator 120 that generates a custom role and assigns the custom role to a user, an access controller 130 that controls access to content data, the storage 140 that stores content data, and the API 150 that allows data exchange between the storage 140 and terminals 400 in both directions.

The attribute manager 110 manages attributes of content data to be stored in the storage 140. More specifically, the attribute manager 110 holds attribute management information for managing the attributes of content data as parameters.

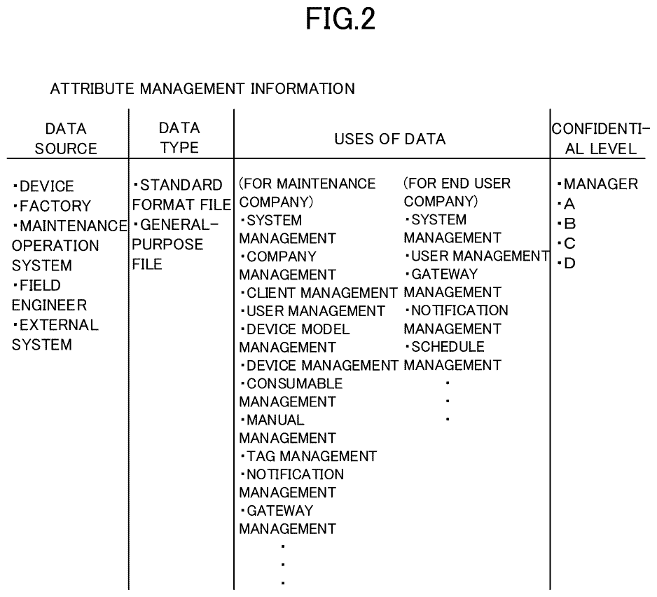

As illustrated in FIG. 2, the attribute management information includes data sources each specifying the device 200 that has generated the content data, data types each indicating an output form of the data, uses of data (for maintenance company) and uses of data (for end user company) indicating the uses of information included in the content data, and confidential levels each indicating the level of confidentiality of the content data. The data source may be information indicating the installation location of the device 200, the system that has generated the content data, or the user that has created the content data. When the role generator 120 generates a custom role, the attribute manager 110 provides the management information to the role generator 120. The data source is an example of generator information.

When receiving content data including the operation data of a device 200 through the gateway 300, the attribute manager 110 appends attribute information to the received content data based on a preset rule. The process of appending attribute information to content data is described in detail later. The attribute manager 110 is an example of attribute information appender.

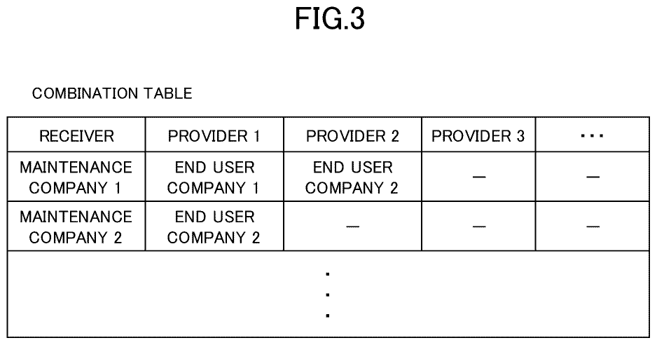

Referring back to FIG. 1, the role generator 120 generates a custom role based on the attribute management information managed by the attribute manager 110, and assigns the generated custom role to a user in a maintenance company or an end user company. The custom role indicates information about conditions for the user in the maintenance company authorized by the end user company to access the content data held by the end user company or conditions for the user in the end user company to access the content data held by the end user company. More specifically, the role generator 120 generates and holds a combination table indicating combinations of end user companies serving as information providers and the corresponding maintenance companies serving as information receivers. For example, the combination table is set and generated by a manager in the maintenance company. As illustrated in FIG. 3, the combination table includes receivers specifying information receiver companies and providers 1, 2, 3, . . . specifying information provider companies. In the illustrated example, a maintenance company 1 as an information receiver receives content data from end user companies 1 and 2. When the role generator 120 generates a custom role for the maintenance company, the custom role is generated for accessing the content data held by the end user company set in the combination table. The combination table is an example of combination information.

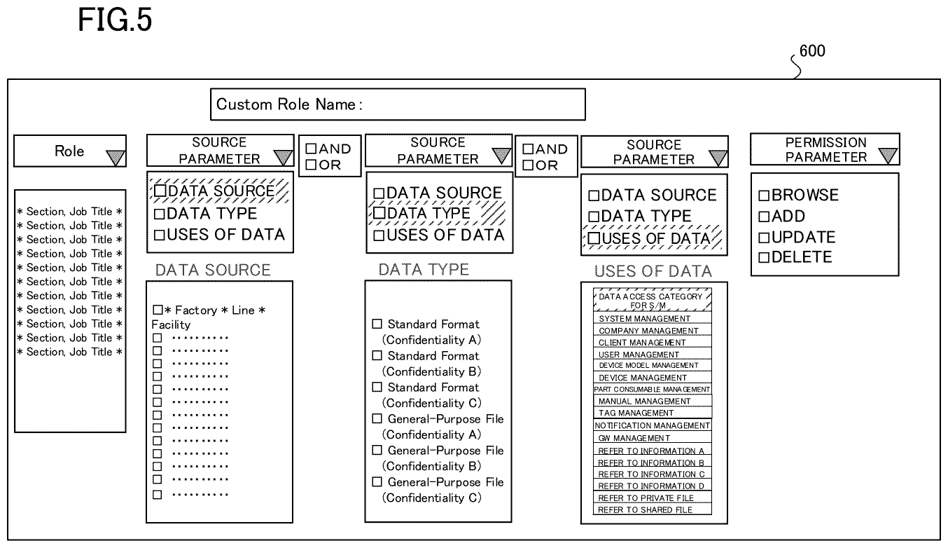

The role generator 120 generates a role definition table defining custom roles based on a setting operation performed on a custom role creation screen 600 in FIG. 5 by managers in maintenance companies and end user companies. To control access to content data provided by a maintenance company, the role generator 120 may generate a custom role specifying conditions for permitting the end user company to access content data held by the maintenance company or a custom role specifying conditions for permitting a user in the maintenance company to access content data held by the maintenance company.

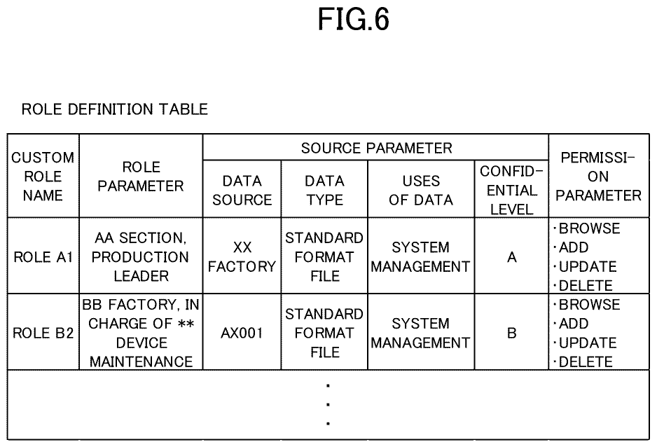

As illustrated in FIG. 6, the role definition table is a table for managing multiple custom roles usable for each company as one group. The role definition table includes custom role names each specifying a custom role, role parameters each indicating the role of the user assigned with a custom role, source parameters each indicating attribute information of content data to be accessed, and permission parameters each indicating access permission allowed for the corresponding custom role. The source parameters are parameters based on the attribute management information held by the attribute manager 110. The source parameters include four types of parameters, or more specifically, data sources, data types, uses of data, and confidential levels. In the illustrated example, the role of the user assigned with the custom role A1 is a production leader in AA section. This user can access the content data generated by XX factory, with the data type being a standard format file, the uses of data being system management, and the confidential level being A. The user assigned with the custom role A1 has operation permission of browsing, updating, deleting, and adding the content data having the attributes indicated as the source parameters. The role definition table may eliminate the custom role names, and use the role parameters as identification information of each custom role. The role generator 120 generates and holds the role definition table for each company. The method for setting custom roles performed by a user is described later. The role definition table is an example of role information. The source parameter is an example of an attribute condition.

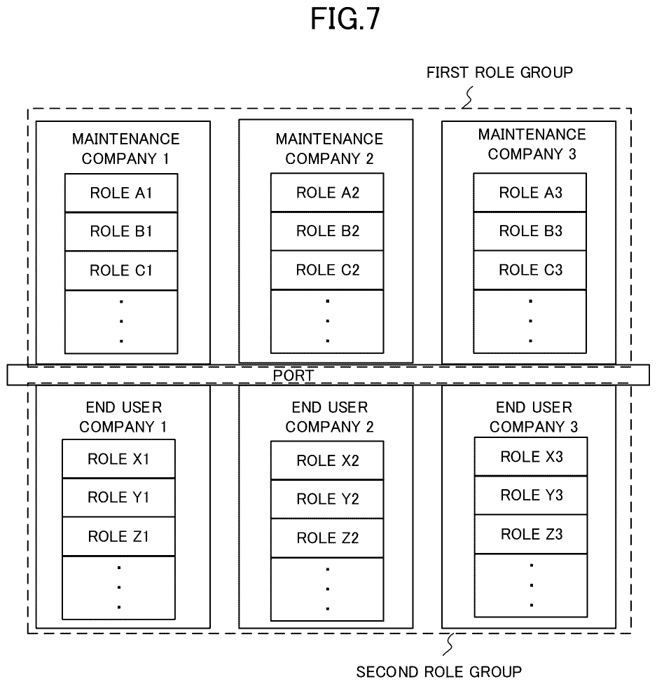

The role generator 120 separately manages a role definition table for each maintenance company serving as a receiver of content data and a role definition table for each end user company serving as a provider of content data. As illustrated in FIG. 7, the role generator 120 sets a first role group indicating a set of role definition tables for multiple maintenance companies and a second role group indicating a set of role definition tables for multiple end user companies. Each maintenance company shares the role definition table for the maintenance company with the corresponding one or more end user companies. Each end user company shares the role definition table for the end user company with the corresponding maintenance company. The role definition tables are shared through ports for accessing the respective role definition tables. More specifically, in the illustrated example, when a maintenance company 1 receives content data from an end user company 1, the role generator 120 sets a port through which the maintenance company 1 accesses the custom roles in the end user company 1 and a port through which the end user company 1 accesses the custom roles in the maintenance company 1. These ports allow managing the multiple maintenance companies as a group and managing user companies that receive remote maintenance support operations from the corresponding maintenance company as a group. The role generator 120 manages the role definition tables included in the first role group to be browsable, copiable, and correctable. The role generator 120 manages the role definition tables included in the second role group to be browsable and copiable, but uncorrectable. This allows, for example, the end user company 1 serving as an information provider to browse, through the set ports, the role definition table created by the maintenance company 1 to authorize the user in the maintenance company, or set or correct the source parameters or the permission parameters in the role definition table. The maintenance company 1 serving as an information receiver can copy one or more custom roles from the role definition table created by the end user company 1 for users in the end user company 1, and use the one or more custom roles as custom roles to be assigned to users in the maintenance company 1.

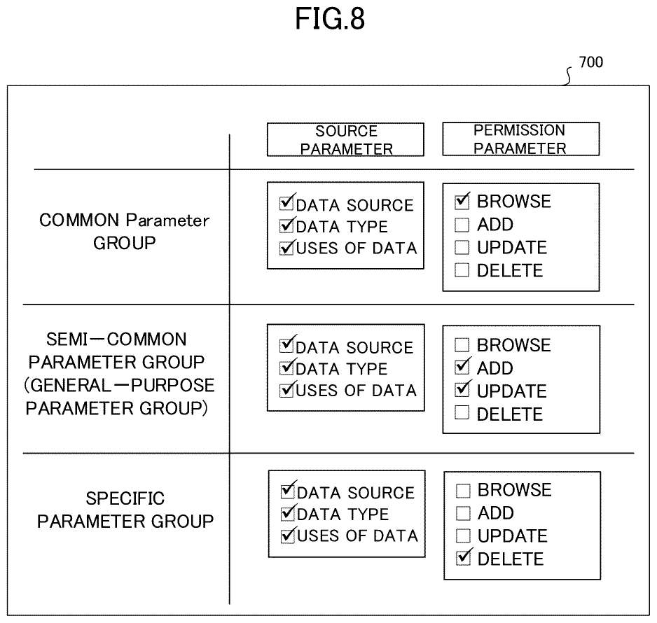

Referring back to FIG. 1, when the maintenance company that receives content data creates one or more custom roles, the role generator 120 determines the range of the source parameters or the permission parameters that can be set. More specifically, the role generator 120 sets the parameter range based on a change parameter setting screen 700 for setting the parameter ranges that can be set by the maintenance company illustrated in FIG. 8. The change parameter setting screen 700 is displayed on a screen of the terminal 400 operated by the manager in the end user company. As illustrated, the change parameter setting screen 700 is a screen used to set a common parameter group indicating a parameter group settable by all the maintenance companies authorized by an end user company, a semi-common parameter group (general-purpose parameter group) indicating a parameter group settable by authorized one or more of the maintenance companies, and a specific parameter group indicating a parameter group settable by the end user company. In the illustrated example, the common parameter group has ticks in the data source, the data type, and the uses of data in the source parameters and has a tick in the browsing in the permission parameters. This indicates that all the maintenance companies authorized by the end user company can create a custom role providing permission to browse the content data provided by the end user company.

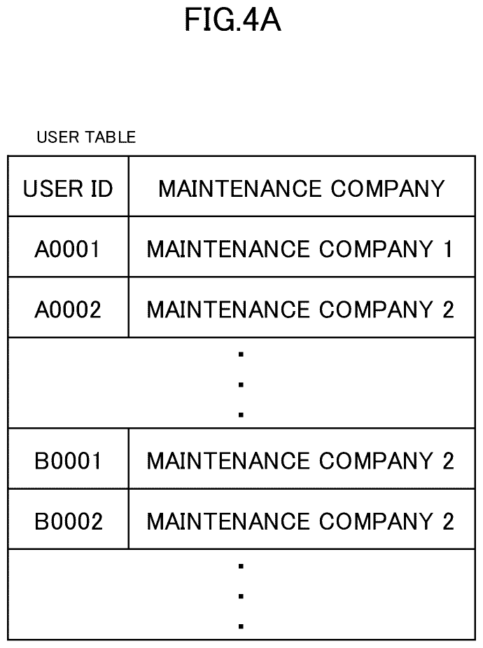

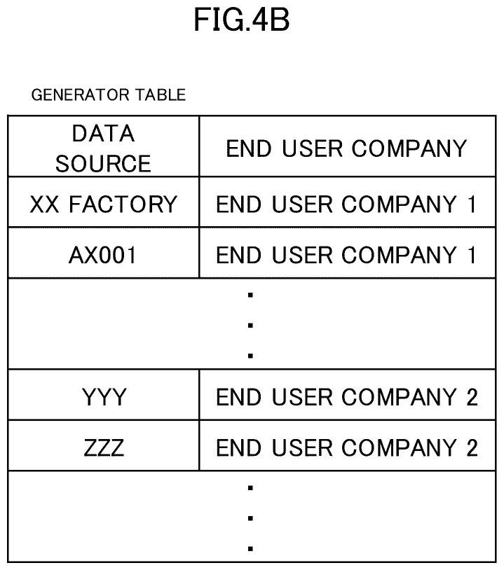

Referring back to FIG. 1, when a custom role is assigned to the user in each maintenance company or the end user company by the manager in the maintenance company or the end user company, the role generator 120 generates assignment information indicating the assignment of the custom role to each user. More specifically, the role generator 120 holds a user table illustrated in FIG. 4A and a generator table illustrated in FIG. 4B. The user table in FIG. 4A links each user identification (ID) identifying a user with the identification information of the maintenance company to which the user belongs. The generator table in FIG. 4B links each parameter indicating a data source appended to a custom role with the identification information of the end user to which the data source belongs. The role generator 120 identifies the maintenance company to which the user belongs by referring to the user table in FIG. 4A. The role generator 120 then reads, from the role definition table in FIG. 6, the parameter of the data source of the custom role to be assigned. The role generator 120 then identifies the end user company serving as a provider and corresponding to the parameter of the data source by referring to the generator table in FIG. 4B. The role generator 120 then determines, by referring to the combination table illustrated in FIG. 3, whether the maintenance company to which the user belongs has received content data from the identified end user company. When determining that the maintenance company to which the user belongs has received content data from the identified end user company, the role generator 120 assigns the custom role to each user to generate the assignment information indicating assignment of the custom role for the user. The process of generating the assignment information is described in detail later. The role generator 120 is an example of an assignor. The generator table is an example of association information.

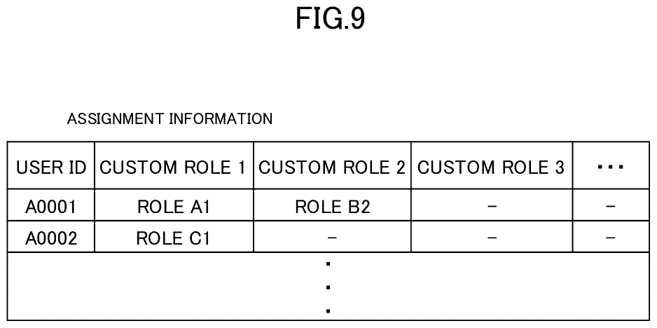

As illustrated in FIG. 9, the assignment information includes user IDs identifying users, and custom role numbers, or more specifically, a custom role 1, a custom role 2, a custom role 3, . . . identifying the custom role assigned to each user. Each user ID is, for example, a login ID preassigned to the user in the maintenance company or the end user company for accessing the storage 140 using the terminal 400. The assignment information is generated for each company.

Referring back to FIG. 1, the access controller 130 controls access to the content data stored in the storage 140 based on the custom role assigned to each user and the attribute information of the content data.

More specifically, when a request to access the content data is generated, the access controller 130 identifies the custom role assigned to the user by referring to the assignment information illustrated in FIG. 9. The access controller 130 acquires, by referring to the role definition table illustrated in FIG. 6, the source parameter and the permission parameter set for the identified custom role. The access controller 130 determines whether the attribute information appended to the content data matches the source parameter and determines whether the specific operation of the user matches the permission parameter. For example, when the user assigned with the custom role A1 performs an operation to browse a piece of content data, the access controller 130 determines whether the attribute information of the content data matches the source parameter of the role A1. When determining that the attribute information of the content data matches the source parameter of the role A1, the access controller 130 determines whether the role A1 has the permission parameter of browsing. In the illustrated example, the role A1 has the permission parameter of browsing. Thus, the access controller 130 determines that the user has the permission parameter of browsing, and permits the user to browse the content data. The access controller 130 is an example of a determiner.

Referring back to FIG. 1, the storage 140 stores operation data generated by the devices 200 and various items of content data created by the user in each maintenance company or each end user company. The attribute information illustrated in FIG. 2 is appended to each piece of content data by the attribute manager 110 or the user.

The API 150 is an interface for allowing data exchange between the storage 140 and the terminals 400 in both directions. More specifically, the API 150 transmits, from the storage 140 to the terminals 400, the content data for which access is permitted by the access controller 130. The API 150 receives, through the terminals 400, content data created by the user in each end user company and permitted for access by the access controller 130.

Each device 200 is a control device that controls, for example, actuators or sensors in a factory, or the actuators and the sensors. Data collected by the information management controller 100 includes data acquired by, for example, a vibration sensor, a temperature sensor, a pressure sensor, or a flow sensor included in each device 200.

The gateway 300 collects data from the devices 200 and transmits the collected data to the information management controller 100. For example, the gateway 300 processes or files the collected data, or determines the uses of the collected data.

Each terminal 400 is, for example, a desktop personal computer, a laptop personal computer, a smartphone, or a tablet device. The users in the maintenance companies and the end user companies each use the corresponding terminal 400 to access content data registered with the storage 140 to perform operations on the content data, such as browsing, registering, deleting, or updating. Each terminal 400 receives a login request for accessing the storage 140 from the terminal 400 based on an instruction from the user. The login request includes, for example, a user ID and a password. Each terminal 400 transmits the acquired login to the information management controller 100. When the user is determined as an authorized user, the terminal 400 permits access to the storage 140. Each terminal 400 is used by the corresponding user to register the content data created by the user with the storage 140. The users in the maintenance companies and the end user companies each create the custom role using the custom role creation screen 600 illustrated in FIG. 5 displayed on the screen of the corresponding terminal 400.

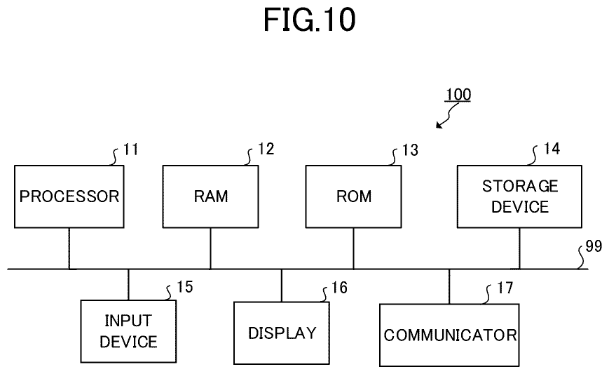

With reference to FIG. 10, the physical structure of the information management controller 100 is now described. The information management controller 100 may be on a cloud server. The information management controller 100 includes a processor 11 that performs processes based on programs, a random-access memory (RAM) 12 that is a volatile memory, a read-only memory 13 (ROM) that is a nonvolatile memory, a storage device 14 that stores data, an input device 15 that receives inputs of information, a display 16 that visually displays information, and a communicator 17 that transmits and receives information. These components are connected to one another with an internal bus 99.

The processor 11 includes a central processing unit (CPU). The processor 11 performs various processes by loading the programs stored in the storage device 14 into the RAM 12 and executing the programs. The processor 11 performs processes of the attribute manager 110, the role generator 120, and the access controller 130 as main functions provided by the programs.

The RAM 12 is used as a work area for the CPU. The ROM 13 stores, for example, control programs or Basic Input/Output System (BIOS) executed by the CPU as basic operations of the information management controller 100.

The storage device 14 includes a hard disk drive, stores programs to be executed by the CPU, and stores various types of data used to execute the programs. The storage device 14 functions as the storage 140.

The input device 15 is a user interface including a keyboard and a mouse. The display 16 is, for example, a liquid crystal display or an organic electroluminescent (EL) display that visually displays information.

The communicator 17 is a network terminator or a radio communication device connected to a network, and a serial interface or a local area network (LAN) interface connected to the network terminator or the radio communication device. The communicator 17 receives external signals to output data indicated by the signals to the processor 11.

The operation of the information management controller 100 with the above structure is now described.

### Custom Role Creation Process

The information management controller 100 controls access to content data based on the custom role assigned to the user who accesses the content data provided by end user companies serving as information providers. The process of creating custom roles is now described. In the example described below, the maintenance company serving as an information receiver creates a custom role.

More specifically, a manager in the maintenance company creates custom roles by operating the custom role creation screen 600 displayed on the terminal 400 for creating custom roles, as illustrated in FIG. 5.

As illustrated, the custom role creation screen 600 includes an input form to receive an input of the custom role name for specifying the custom role, a role tab for setting the role of the user to which each custom role is assigned, a source parameter tab for setting the attribute of accessible content data, and permission parameter tab for setting the access permission to be assigned to each custom role.

The source parameter tab includes multiple tabs for setting source parameters including the data source specifying the device 200 that has generated the content data or the location in which the content data is generated, the data type indicating the output form and the confidential level of the content data, and the uses of data indicating the uses of information included in the content data. The manager in the maintenance company chooses an item among the preset options for each parameter to create the custom roles. The role generator 120 generates the role definition table illustrated in FIG. 6 based on the custom roles created by the manager in the maintenance company. The information displayed as the options of the source parameter is information held by the attribute manager 110 based on the attribute management information illustrated in FIG. 2. A combination of attributes may be defined as the attribute management information. In this case, the order of the data source, the data type, and the uses of data in the source parameter tabs may be switched on the custom role creation screen 600 to narrow the options for display. When the range of parameters settable by each maintenance company is preset using the change parameter setting screen 700 illustrated in FIG. 8, the custom role creation screen 600 for the maintenance company may display the parameters out of the setting range in an unchangeable manner.

The manager in each maintenance company assigns the generated custom roles to users. The manager in the maintenance company causes each terminal 400 to display an input screen for assigning a custom role to assign, on the input screen, the custom role name specifying the custom role to the user ID identifying the user. More specifically, the role generator 120 holds the user table illustrated in FIG. 4A and the generator table illustrated in FIG. 4B. The user table in FIG. 4A links each user ID identifying the user with the identification information of the maintenance company to which the user belongs. The generator table in FIG. 4B links each parameter indicating the data source appended to a custom role with the identification information of the end user company to which the data source belongs. For example, when the role generator 120 assigns the role A1 in the role definition table illustrated in FIG. 6 to the user with a user ID A0001, the role generator 120 identifies the user A0001 as a user belonging to the maintenance company 1 by referring to the user table in FIG. 4A. The role generator 120 then reads, from the role definition table in FIG. 6, the data source for the role A1 being XX factory. The role generator 120 then identifies XX factory as a factory of the end user company 1 by referring to the generator table in FIG. 4B. The role generator 120 then determines whether the maintenance company 1 is provided with content data by the end user company 1 by referring to the combination table illustrated in FIG. 3. In the illustrated example, the providers corresponding to the maintenance company 1 include the end user company 1. Thus, the role generator 120 assigns the role A1 to the user A0001 to generate assignment information indicating the assignment of the custom role for each user. The role generator 120 generates, based on the operation performed by the manager in the maintenance company, assignment information illustrated in FIG. 9 for transmission to the access controller 130.

The manager in the maintenance company can copy the role definition information created by the end user company for the user in the end user company to create the custom role for the user in the maintenance company. More specifically, the manager in the maintenance company causes the corresponding terminal 400 to display a screen for reading the role definition information and inputs the identification information of the end user company into the input form. The role generator 120 determines, by referring to the combination table illustrated in FIG. 3, whether the end user company identified by the input identification information permits access from the maintenance company. When the role generator 120 determines that the end user company permits access, the role generator 120 transmits the role definition table for the end user company illustrated in FIG. 6 to the terminal 400 through a preset port. The manager in the maintenance company chooses the custom role from the role definition table for the end user company and adds the custom role to the role definition table for the maintenance company. The manager in the maintenance company causes the terminal 400 to display an input screen for assigning the custom role and assigns, on the input screen, the custom role name specifying the custom role to the user ID specifying the user.

### Content Data Registration Process

The process performed by the information management controller 100 for storing content data into the storage 140 is now described. The information management controller 100 stores, into the storage 140, content data including the operation data of the devices 200 possessed by end user companies and generated by the devices 200 and content data created by users in the end user companies.

The process for storing the operation data generated by each device 200 is first described. When receiving the operation data of the device 200 through the gateway 300, the attribute manager 110 in the information management controller 100 appends attribute information to the received operation data based on a preset rule.

More specifically, for example, the attribute manager 110 holds an association table defining association between the address information of each device 200 and the device ID uniquely identifying the corresponding device 200. The attribute manager 110 converts the address information of the device 200 included in the received operation data to the device ID based on the association table, and appends the device ID to the operation data as attribute information indicating the data source. For example, the attribute manager 110 appends attribute information indicating the data type to the received operation data based on a preset rule, such as a rule for classifying the data type of the operation data having time described in column information as a standard format file and classifying the data type of the other operation data as a general-purpose file. In another case, for example, the attribute manager 110 appends attribute information indicating a confidential level to the received content data based on a rule for determining the confidential level of the content data based on a combination of parameters of the attribute information. The attribute manager 110 links the operation data having these pieces of attribute information with identification information uniquely identifying the operation data for storage into the storage 140.

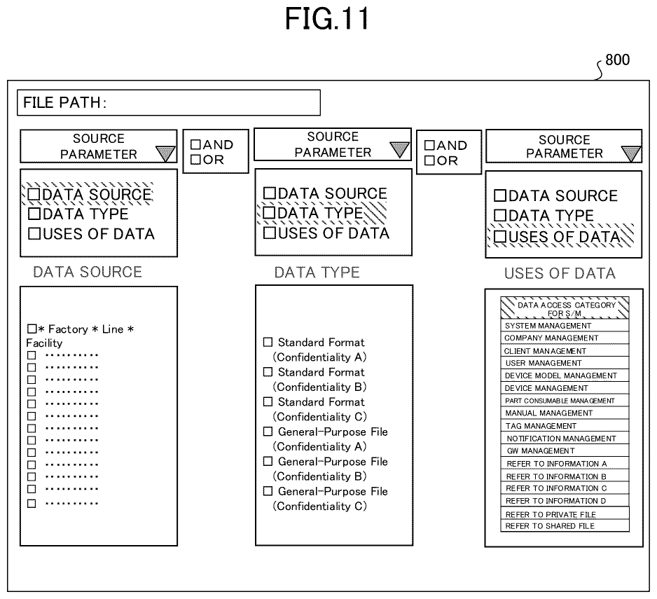

A process of storing the content data created by users in end user companies into the storage 140 is now described. Each user causes the corresponding terminal 400 to display an input screen 800 for appending attribute information to the content data illustrated in FIG. 11 to append the attribute information to the content data on the input screen 800. As illustrated, the input screen 800 includes a file path for receiving an input of an address at which the content data registered with the storage 140 is to be stored, and source parameter tabs for setting the attribute to be appended to the content data. The user chooses an item among preset options for each source parameter, and sets the attribute information to be appended to the content data identified by the address input into the file path. The attribute manager 110 appends the attribute information set by the user to the content data, links the content data with the identification information uniquely identifying the content data, and causes the storage 140 to store the content data.

### Access Control Process

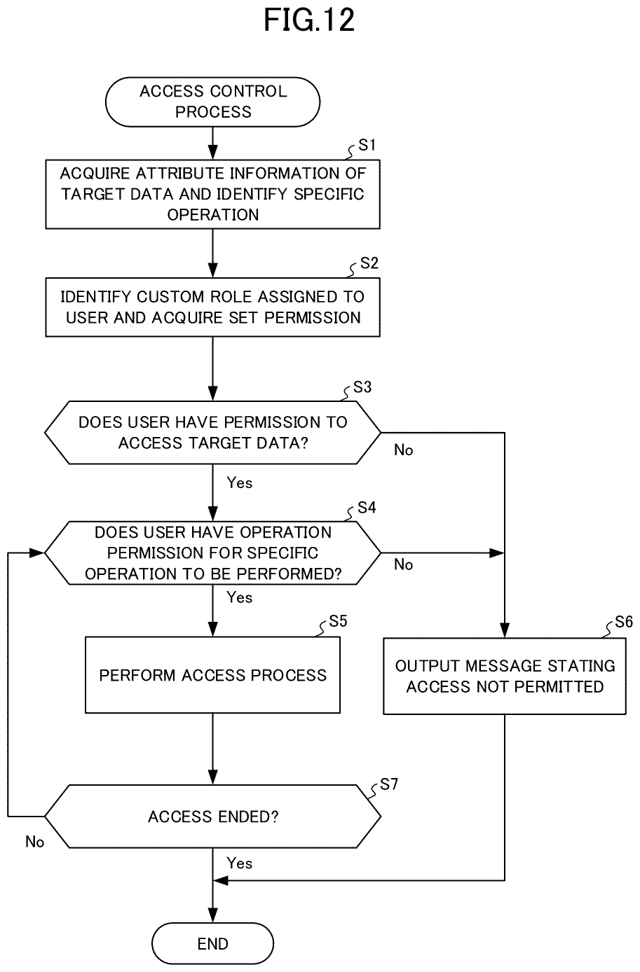

The operation of an access control process for controlling access to the content data stored in the storage 140 is now described with reference to FIG. 12. In the example described below, a user in the maintenance company 1 browses the content data registered by the end user company 1.

When the user generates a request for access to the content data, the information management controller 100 starts the access control process.

The access controller 130 in the information management controller 100 acquires the attribute information of the accessed content data and identifies the specific operation performed by the user (step S1). More specifically, when the user double-clicks the content data to browse the content data, the access controller 130 acquires the attribute information indicating the data source, the data type, the uses of data, and the confidential level appended to the content data from the storage 140. The access controller 130 then identifies the specific operation as browsing based on the double-clicking operation of the user.

The access controller 130 then identifies the custom role assigned to the user and acquires permission set for the identified custom role (step S2). More specifically, the access controller 130 refers to the assignment information illustrated in FIG. 9, and identifies the custom role assigned to the user. When the user accessing the content data has a user ID A0001, the access controller 130 identifies the user as a user assigned with the custom roles A1 and B2.

The access controller 130 then acquires the access permission of the roles A1 and B2 by referring to the role definition table illustrated in FIG. 6. The access controller 130 reads the source parameter and the permission parameter defined for each custom role. The access controller 130 acquires, as the access permission of the role A1, the attributes of accessible content data, or more specifically, acquires XX factory for the data source, the standard format file for the data type, the system management for the uses of data, A or lower than A for the confidential level, and browsing, updating, deleting, and adding for operations permitted. The access controller 130 acquires the access permission of the role B2 in the same manner as for the access permission of the role A1.

Referring back to FIG. 12, the access controller 130 then determines whether the user has permission to access to the target content data (step S3). More specifically, the access controller 130 determines whether the user has access permission based on the attribute information of content data acquired in step S1 and the source parameters of the roles A1 and B2 acquired in step S2. The access controller 130 determines whether the source parameters of the roles A1 and B2 include the attribute information, or more specifically, the data source, the data type, the uses of data, and the confidential level appended to the content data. When determining that the source parameters include the attribute information (Yes in step S3), the access controller 130 advances to the processing in step S4. When the access controller 130 determines that the source parameters of the roles A1 and B2 do not include the attribute information, or more specifically, the data source, the data type, the uses of data, and the confidential level appended to the content data (No in step S3), the access controller 130 determines that the user does not have permission to access the content data. The access controller 130 then outputs a message stating access not permitted (step S6) and ends the process.

Referring back to step S4, the access controller 130 then determines whether the user has operation permission for the specific operation to be performed. More specifically, the access controller 130 determines whether the specific operation specified in step S1 is included in the permission parameter acquired in step S2. As illustrated in FIG. 6, the operation parameters for the roles A1 and B2 correspond to browsing, updating, deleting, and adding. The operation parameters include browsing identified in step S1. Thus, the access controller 130 determines that the operation permission for browsing is included (Yes in step S4), and performs an access process for browsing of the target data (step S5).

When the access controller 130 determines that the user does not have operation permission for the specific operation to be performed (No in step S4), the access controller 130 outputs a message stating access not permitted (step S6), and ends the process.

Referring back to step S5, the access controller 130 then determines whether access to the target data has ended. More specifically, when the user performs an operation to close the screen showing the target data, the access controller 130 determines that the access to the target data has been ended (step S7), and ends the access control process.

When the user performs other operations, or for example, adds information to the target data or deletes information from the target data, the access controller 130 determines that the user has not ended the access to the target data (No in step S7), and returns to step S4 to determine whether the user has operation permission for the newly performed specific operation.

As described above, the information management controller 100 appends, to the content data, the data source for specifying the device 200 that has generated the content data and generates the custom role for which the access permission including the conditions about the data source is set. The information management controller 100 assigns the custom role to the user in the maintenance company authorized by the end user company serving as an information provider identified by this data source. The information management controller 100 determines whether access is permitted based on the access permission set for the assigned custom role and the attribute information appended to the content data. The information management controller 100 can thus appropriately manage the permission to access information provided by various providers.

The information management controller 100 allows each end user company to share the role definition information created by the end user company with the corresponding one or more maintenance companies and allows the one or more maintenance companies to share the role definition information created by the one or more maintenance companies with the end user company. Thus, for example, the maintenance company can generate the custom role for the maintenance company using the role definition information created by the end user company for the user in the end user company. This reduces time and effort for achieving information management using access control.

Although the embodiments of the present disclosure have been described above, the present disclosure is not limited to the above embodiments.

In the above embodiments, the content data provided by each end user company is shared with the corresponding maintenance company. In another embodiment, the content data in each maintenance company may be shared with the corresponding end user company. In this case, the role generator 120 sets, in the combination table in FIG. 3, the end user company as a receiver and the maintenance company as a provider. The role generator 120 also holds a user table linking each user ID for the end user company with the identification information of the end user company, and a generator table linking the identification information of the data source with the identification information of the end user company. In the role group control diagram illustrated in FIG. 7, the custom roles for each end user company are set in the first role group indicating the custom role group for information receiver companies, and the custom roles for each maintenance company are set in the second role group indicating the custom role group for information provider companies. Additionally, the identification information for identifying, for example, the factory or the office of each maintenance company may be added to the data source that is the source parameter in the role definition table illustrated in FIG. 6 and the attribute information of content data.

In the above embodiments, the information management control system 1 is used by the maintenance company that manufactures the devices 200 and the end user companies that use the devices 200 manufactured by the maintenance company. However, the combination of companies that use the information management control system 1 is not limited to the above example. For example, the combination may include, for example, a product manufacturer and a part manufacturer, or a manufacturer and a system integrator that introduces or maintains a manufactured device.

In the above embodiments, the content data stored in the storage 140 is data about the devices 200, such as the operation data of the devices 200, data output from various sensors, the drawing data, the task history, the maintenance history, the part masters, and the manuals of the devices 200. However, the content is not limited to these. For example, the storage 140 may store data not about the maintenance of the devices 200, such as client data, sales data, personnel data, marketing data, or quality management data.

In the above embodiments, the functions of the attribute manager 110, the role generator 120, and the access controller 130 included in the information management controller 100 are implemented by a single computer, but may be implemented by multiple computers. For example, the function of the attribute manager 110 may be implemented by an edge computer installed at a manufacturing site. For example, the API 150 may have a function of the access controller 130 to implement the access control process.

The information management controller 100 may eliminate the storage 140. The content data stored in the storage 140 may be collectively managed by a cloud server on a network. The attribute manager 110 and the access controller 130 may access the cloud server as appropriate to read or write information.

The functions of the information management controller 100 may be implemented by a normal computer system, rather than by a dedicated device. For example, programs for implementing the functions of the information management controller 100 may be stored in a non-transitory computer-readable recording medium, such as a compact disc read-only memory (CD-ROM) or a digital versatile disc read-only memory (DVD-ROM), and may then be distributed. Such programs may be installed on a computer to provide a computer that can implement the above functions.

When the functions are implemented partially by the operating system (OS) and partially by applications or implemented through cooperation between the OS and applications, the applications alone may be stored in the non-transitory recording medium.

The components described in the above embodiments may be selected or modified as appropriate without departing from the spirit and scope of the present disclosure.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Information management control system
100 Information management controller
110 Attribute manager
120 Role generator
130 Access controller
140 Storage
150 API
200 Device
300 Gateway
400 Terminal
500 Network
600 Custom role creation screen
700 Change parameter setting screen
800 Input screen
11 Processor
12 RAM
13 ROM
14 Storage device
15 Input device
16 Display
17 Communicator
99 Internal bus

1. An information management controller for managing content data including operation data of a management target device and controlling access to the content data, the information management controller comprising:
attribute information appending circuitry to append attribute information to the content data based on a preset rule, the attribute information including generator information for identifying a device being a generator of the content data;
role generation circuitry to generate role information including the generator information of the content data, the role information indicating a condition for allowing access to the content data;
assignment circuitry to identify a provider of the content data based on association information including the generator information included in the role information generated by the role generation circuitry in a manner associated with the provider of the content data generated by the device identified by the generator information, and to assign the role information generated by the role generation circuitry to a user in a receiver of the content data authorized by the identified provider; and
determination circuitry to determine whether a user requesting access to the content data is permitted to access the content data based on the attribute information appended to the content data and the condition indicated by the role information assigned to the user.

2. The information management controller according to claim 1, wherein
the role generation circuitry generates the role information for each of a plurality of providers, and
the assignment circuitry assigns the role information generated by the role generation circuitry to a user in each of a plurality of receivers based on combination information indicating association between each of the plurality of providers and a corresponding receiver of the plurality of receivers.

3. The information management controller according to claim 1, wherein
the role generation circuitry generates the role information to be assigned to a user in the provider of the content data and the role information to be assigned to a user in the receiver of the content data, and provides the role information assigned to the user in the provider to the user in the receiver based on a preset rule, and
the assignment circuitry assigns, to the user in the receiver, the role information provided to the user in the receiver by the role generation circuitry.

4. The information management controller according to claim 1, wherein
the role information includes an attribute condition defined by a combination of a plurality of attributes appended to the content data being accessible.

5. The information management controller according to claim 1, wherein
the role information includes operation permission indicating a specific operation allowed to be performed on the content data, and
the determination circuitry determines whether a specific operation to be performed by the user requesting access on the content data is included in the operation permission in the role information assigned to the user, and permits, when determining that the specific operation is included, the specific operation to be performed on the content data.

6. An information management control system, comprising:
the information management controller according to claim 1,
a storage to store the content data included in the information management controller; and
a gateway to acquire the content data from a management target device and transmit the content data to the information management controller.

7. An information management control method for causing a computer to perform operations comprising:
generating role information including generator information for identifying a device being a generator of content data, the role information indicating a condition for allowing access to the content data;
identifying a provider of the content data based on association information including the generator information included in the generated role information in a manner associated with the provider of the content data generated by the device identified by the generator information, and assigning the generated role information to a user in a receiver of the content data authorized by the identified provider; and
determining whether a user requesting access to the content data is permitted to access the content data based on attribute information appended to the content data and including the generator information and the condition indicated by the role information assigned to the user.

8. A non-transitory computer-readable recording medium storing a program executable by a computer for managing content data including operation data of a management target device and controlling access to the content data, the program causing the computer to perform operations comprising:
generating role information including generator information for identifying a device being a generator of the content data, the role information indicating a condition for allowing access to the content data;
identifying a provider of the content data based on association information including the generator information included in the generated role information in a manner associated with the provider of the content data generated by the device identified by the generator information, and assigning the generated role information to a user in a receiver of the content data authorized by the identified provider; and
determining whether a user requesting access to the content data is permitted to access the content data based on attribute information appended to the content data and including the generator information and the condition indicated by the role information assigned to the user.
